(19) United States
(12) Patent Application Publication
(10) Pub. No.: US 2020/0223178 A1
(43) Pub. Date: Jul. 16, 2020

(54) FIBROUS STRUCTURE PRODUCTS COMPRISING LAYERS EACH HAVING DIFFERENT LEVELS OF CELLULOSE NANOPARTICLES

(71) Applicant: Mercer International Inc., Vancouver (CA)

(72) Inventor: Tobias Ziegenbein, Vancouver (CA)

(21) Appl. No.: 16/697,060

(22) Filed: Nov. 26, 2019

Related U.S. Application Data
(60) Provisional application No. 62/771,525, filed on Nov. 26, 2018.

(51) Int. Cl. B32B 5/26; B32B 5/30

(52) U.S. Cl. CPC B32B 5/26; B32B 5/30; B32B 2262/067; B32B 2250/20; B32B 2250/02

(57) ABSTRACT

A fibrous structure having at least two layers is disclosed. Each of the at least two layers has a mixture of structural fibers selected from the group consisting of softwood fibers, non-wood fibers, natural non-cellulosic fibers, man-made cellulosic or non-cellulosic fibers, hardwood fibers, recycled fibers, and mixtures thereof. Each of the at least two layers are disposed in a face-to-face relationship. A second layer of the at least two layers has from about 0.05 percent to about 20 percent by weight of the second layer of cellulose nanoparticles.

### FIELD OF THE INVENTION

The present disclosure relates to paper web products comprising cellulose nanoparticles. More specifically, the products are layered paper fiber structures where the layers have non-uniform levels of cellulose nanoparticles. Using selected non-uniform levels of cellulose nanoparticles provides the product designer additional degrees of freedom in optimizing the user performance benefits of the produced product.

### BACKGROUND OF THE INVENTION

Paper products, such as fine papers, printing papers, paper boards, cement/fiber composites, facial tissues, paper towels, bath tissues, napkins and other similar products, are designed to deliver a balance of several important properties unique for each product type. For example, tissue products should have good bulk, good absorbency, a soft feel, and should have good strength and durability. In another example, fine printing papers should have high smoothness, optimum brightness and good printability/ink retention.

Unfortunately, the balance of performance properties is generally contained in a limited formulation space or box. Within a product type, when steps are taken to increase one property of the product, other characteristics of the product are often adversely affected. For example, product designers of tissue products have, for years, attempted to balance a lower level of softwood fibers in their paper structures while trying to obtain adequate strength while at the same time trying to minimize the negative impact on softness, sheet bulk or absorbency generally resulting from higher levels of refining these softwood fibers.

In another example, for multi-use fibrous sheets used for paper toweling, napkins and hankies in particular, increased softwood content, increased refining and cationic/anionic polymer addition has been required to achieve strength targets required for durability requirements. However, all of these actions can negatively affect the sheet feel and product absorbency.

In yet another example for printing papers used for commercial or office printing, or personal handwriting, there continues to be a need for increased strength without a corresponding loss in ink penetration/absorbency. This need is compounded as environmental interests push toward higher percentages of recycled pulp and/or higher levels of filler in fine paper products. Higher percentages of recycled pulp, especially repeatedly recycled pulp, leads to degradation of the fibers and as a result lower strength and quality of the paper products produced. Traditionally, this loss in strength has been compensated for by significant increases in synthetic strength additives and resins which, in turn, often results in lower ink absorbency in the product. Similarly, higher levels of filler are also compensated for by significant increases in synthetic strength additives and/or increased levels of refining which, in turn often result in lower bulk. increased printing pick-out and/or lower performing paper structures.

There is a continuing need, in fact a growing need, to be able to develop printing paper products with high strength and impermeability, while maintaining costs and ink absorbency.

In another paper segment, there is also a need for barrier properties that are more environmentally friendly and compostable. Today these barrier properties can only be accomplished through the use of chemicals and other non-organic barrier coating. The targeted use of cellulose nano-particles within specific product layers can create a structure that meets products needs while using a higher percentage of recyclable, compostable and have a higher percentage of natural materials.

Similarly, paper board products are also being impacted by the increases in levels of recycle pulp. For example, board products used for food storage, where lower strength fibers may not only may cause decreased strength but may also result in more permeability of the paper structure. This increased package permeability can lead to a loss of antibacterial protection of the product resulting in shorter product shelf-life. Traditionally, this is compensated for by increase in expensive synthetic additives or by thicker, less permeable plastic coatings, that hamper recyclability and compostability.

Accordingly there continues to be a need for a new fibrous structure that further optimizes the physical product performance of fibrous products, without sacrificing other performance characteristics such as softness, permeability, printability, ink absorption, barrier properties, absorbency and paper/non-woven machine reliability. Those experienced in the field will recognize that all fibrous sheet making processes could benefit from selective addition of cellulose nano particles with non-limiting examples of such structures being produced on conventional papermaking assets, conventional dry crepe tissue machine, differential density or structured tissue papermaking processes, and air-laid papermaking assets machines and products.

### SUMMARY OF THE INVENTION

The present disclosure provides a fibrous structure comprising at least two layers. Each of the at least two layers comprises a mixture of structural fibers selected from the group consisting of softwood fibers, non-wood fibers, natural non-cellulosic fibers, man-made cellulosic or non-cellulosic fibers, hardwood fibers, recycled fibers, and mixtures thereof. Each of the at least two layers are disposed in a face-to-face relationship. A second layer of the at least two layers comprising from about 0.05 percent to about 20 percent by weight of the second layer of cellulose nanoparticles.

The present disclosure also provides a fibrous structure having a surface layer comprising high aspect ratio nanofilaments.

The present disclosure further provides a fibrous structure having a machine direction and a cross-machine direction orthogonal and co-planar thereto and comprising at least two plies disposed in a contacting face-to-face relationship. Each of the at least two plies comprised a mixture of structural fibers selected from the group consisting of softwood fibers, non-wood fibers, natural non-cellulosic fibers, man-made cellulosic or non-cellulosic fibers, hardwood fibers, recycled fibers, and mixtures thereof. A first ply of the at least two plies comprises a first layer comprising from about 0.05 percent to about 20 percent by weight of the first layer of cellulose nanoparticles.

### BRIEF DESCRIPTION OF THE DRAWINGS

FIG. 1 is an exemplary cross sectional view of a two layer embodiment of the fibrous substrate of the present disclosure.

FIG. 2 is an exemplary cross sectional view of a three layer embodiment of the fibrous substrate according to the present disclosure where an outer layer of the substrate comprises the cellulose nanoparticles.

FIG. 3 is an exemplary cross sectional view of a three layer embodiment of the fibrous substrate according to the present disclosure where an inner layer of the substrate comprises the cellulose nanoparticles.

FIG. 4 is an exemplary cross sectional view of a two layer embodiment of the fibrous substrate made on a shown forming wire according to the present disclosure where the first layer comprising the cellulose nanoparticles is the layer formed on the face of the forming wire.

FIG. 5 is an exemplary cross sectional view of a two layer embodiment of the fibrous substrate made on a shown forming wire according to the present disclosure where the first layer comprising the cellulose nanoparticles is the layer formed not in contact with the forming wire.

FIG. 6 is an exemplary cross sectional view of a two layer embodiment of the fibrous substrate made in a process comprising two parallel forming wires according to the present disclosure.

FIG. 7 is an exemplary cross sectional view of a two layer embodiment of the fibrous substrate according to the present disclosure where the first layer comprising the high aspect ratio cellulose nanofilaments is a concentrated layer, and therefore a thinner later.

FIG. 8 is an exemplary cross sectional view of a three layer embodiment of the fibrous substrate made on a shown forming wire according to the present disclosure where the first layer comprising the cellulose nanoparticles is the layer formed on the face of the forming wire.

FIG. 9 is an exemplary cross sectional view of a three layer embodiment of the fibrous substrate made in a process comprising two parallel forming wires according to the present disclosure.

FIG. 10 is an exemplary cross sectional view of a three layer embodiment of the fibrous substrate according to the present disclosure where the first layer comprising the cellulose nanoparticles is a concentrated layer, and therefore a thinner later, shown in a face-to-face relationship with the second and third layers of the substrate.

FIG. 11 is an exemplary flow drawing of a typical paper machine.

FIGS. 12A-12E are exemplary flow drawings of typical converting operations suitable for combining two separate layered plies of fibrous material.

### DETAILED DESCRIPTION OF THE INVENTION

Despite many articles related to the use of cellulose nanoparticles in fibrous structures, cellulose nanoparticle nomenclature has not yet been standardized and there is an inconsistent use of terms to describe cellulose particles. The term “cellulose nanoparticles” as used herein refers to cellulose particles having at least one dimension in the nanoscale. Cellulose nanoparticles include but are not limited to, micro-fibrillated cellulose (MFC), nano-fibrillated cellulose (NFC), algae cellulose particles (AC), bacterial cellulose particles (BC), and high aspect ratio cellulose nanofilaments (CNF).

The present disclosure relates to a fibrous substrate 100 comprising at least two layers. A first of these layers 110 and a second of these layers 120 are disposed in a contacting face-to-face relationship. Each of these first and second layers are formed from a plurality of overlapping fibers and other constituents as required for the specific substrate end use and the first of these comprises a plurality of cellulose nanoparticles 150. The layers of the paper web substrate 100 are formed from a plurality of overlapping fibers selected from the group consisting of softwood fibers, non-wood fibers, natural non-cellulosic fibers, man-made cellulosic or non-cellulosic fibers, hardwood fibers and mixtures thereof, fillers, active ingredients and combinations thereof. Preferably the first layer of paper web substrate comprises at least about 0.05 percent by weight of nanoparticles and the second layer comprises no directly added cellulose nanoparticles. In another embodiment, it is envisioned that the at least two layers each contain cellulose nanoparticles, but the composition of cellulose nanoparticles in the layers is different, but each have at least about 0.05 percent by weight of cellulose nanoparticles.

As used herein, “Paper Web Substrate” refers to any wet formed or dry laid, fibrous structure products, traditionally, but not necessarily, comprising cellulose fibers. Embodiments of the paper web substrates may encompass, without being limited to tissue products such as sanitary tissue products, towel products such as absorbent towels, paper board grades, paper packaging substrates, paper used for high pressure laminate construction, paper used for printing and writing and fibrous substrates used for air-laid non-woven products. Other embodiments of the paper web substrates contemplated in the present disclosure also include without limitation, embryonic dry laid webs as used in air-laid making processes encompassing loosely bound “fluff” structures of desired fibers.

“Fibrous structure,” as used herein, means a structure that comprises one or more fiber layers. In one example, a fibrous structure according to the present disclosure means an orderly arrangement of fibers within a structure in order to perform a function. Non-limiting examples of fibrous structures of the present disclosure may include all forms of paper substrates, non-woven substrates along with composite materials (including reinforced plastics and reinforced cement).

As used herein, “converting operation” means an addition processing stage whereby the fibrous structure is coated, combined, embossed, cut, or otherwise treated to make the product better suited for the tasks it is designed to fulfill. These operations may be done either immediately after the web is formed on the paper machine or they may be done at a later time via a separate process and machinery.

Non-limiting examples of processes for making fibrous web structures include known wet-laid papermaking processes and air-laid papermaking (also known as non-woven) processes. Those skilled in the art will recognize that such processes typically include a step for preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous suspension is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in paper making processes finishing may including adding topical treatments either on-line or off-line to make an intermediate structure and/or one or more plies may be combined to create the final substrate. In many fibrous web making processes, the finished fibrous structure is wound or sheeted and may subsequently be converted into a finished product via an additional “converting operation”.

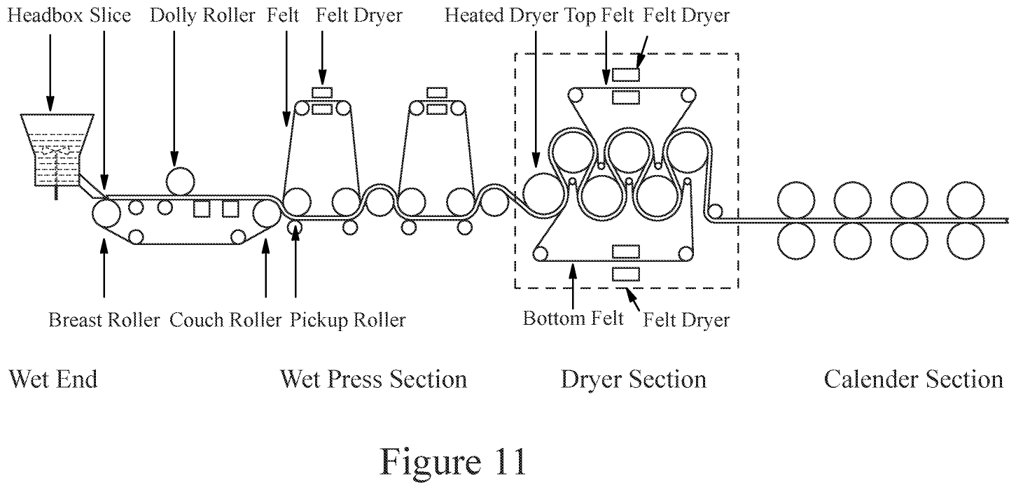

FIG. 11 depicts a non-limiting example of a wet-laid paper machine. There are a least five distinct operational sections on a typical paper machine:
The forming section, commonly called the wet end, takes an aqueous solution of fiber and other constituents and creates an embryonic web (on a dry-laid paper machine, the fiber is dispersed in air before creating the embryonic web).
The press section, which removes a significant amount of the remaining water via a system of nips formed by rolls pressing against each other aided by press felts that support the sheet and absorb the pressed water.
The dryer section of the paper machine, as its name suggests, dries the paper by way of a series of either internally steam-heated cylinders that evaporate the moisture or other external means to dry the web. (On a dry laid paper machine, the press and dryer sections are replaced with a bonding and curing process whereby heat and/or chemicals are used to treat the web to create a final structure.)
The finish section is where the paper is smoothed and or coated/treated to provide specific surface or structural changes such as coating, sizing, surface modification, and/or calendaring under high loading and pressure.
The reel section where paper coming out of the paper machine is wound onto spools for further processing.

There can also be a coating section to modify the surface characteristics with coating with a non-limiting example being kaolin clay.

The papermaking process can be adapted to allow any number of special materials or chemicals to be added to provide special functionality to the finished paper. Sizing agents, such as resins, glue, or starch, can be added to the web to alter its characteristics by improving the paper's water resistance, decreases its ability to fuzz, reducing abrasiveness, and improving its printing properties and surface bond strength. These sizing agents may be applied at the wet end (internal sizing) or on the dry end (surface sizing), or both. At the dry end sizing is usually applied with a size press. The size press may be a roll applicator (flooded nip) or Nozzle applicator. It is usually placed before the last dryer section. Some paper machines also make use of a ‘coater’ to apply a coating of pigments such as calcium carbonate or china clay usually suspended in a binder of cooked starch and styrene-butadiene latex. Coating produces a very smooth, bright surface with the highest printing qualities. Some paper machines also may use calendaring or super calendaring to enhance the surface structure, improve printability and/or alter sheet stiffness.

Those skilled in the art will recognize that the processes to make fibrous webs are very adaptable and customizable to allow the creation of structures for various end uses by either changing basic materials and/or unit operations to better create the desired structure. A non-limiting example of this customization is the addition of a creping blade and larger drying role (Yankee) on some types of tissue machines. Another non-limiting example is the use of a dry defibering (i.e., Hammer mills for “fluffing” dried fiber webs) devices and an air delivery system to create dry/air-laid structures.

In the forming section or wet end of a traditional paper machine, a dilute aqueous mixture of fiber and other product materials is fed into a head box before it is deposited upon a wire. The purpose of the head box is to create turbulence, to prevent fibers from clumping together, and to create a uniform basis weight of material across the paper making machine. Headboxes may contain one or more layers and these layers can have the same or different aqueous solutions fed to them. From the head box the aqueous slurry is deposited onto a moving wire or fabric loop. The slurry is then dewatered as required to create the desired structure.

Again, those skilled in the art will recognize the paper machine can be altered depending upon the desired paper feed materials, basis weight and sheet structure. One non-limiting example modification is the addition of a second headbox added to the wet end to put a different fiber blend on top of a partially formed base layer. A secondary headbox is normally located at a point where the base sheet is completely drained. This is not considered a separate ply because the water action does a good job of intermixing the fibers of the top and bottom layer. Secondary headboxes are common on linerboard production.

Another non-limiting example of a forming/wet end section modification is the addition of a second wire on top of the drainage table. The bottom and top wires converge, and some drainage occurs from both sides of the sheet. A top wire improves formation and also provides more drainage, which is useful for machines to speed up and create specific paper grades at economical speeds. The Twin Wire Machine or Gap former uses two vertical wires in the forming section, thereby increasing the de-watering rate of the fiber slurry while also giving uniform two sidedness.

Tissue Product

A “tissue” or “towel” paper product refers to products produced on paper tissue or paper towel technology including but not limited to, conventional felt pressed or conventional wet-pressed tissue papers, pattern densified tissue papers, through-air dried papers whether creped or un-creped. For example, a paper making process of the present disclosure can utilize adhesive creping, wet creping, double creping, embossing, wet-pressing, air pressing, through-air drying, creped through-air drying, un-creped through-air drying, as well as other steps in forming the paper web. Some examples of such techniques are disclosed in U.S. Pat. Nos. 4,529,480, 5,048,589, 5,399,412, 5,129,988 5,494,554, 5607511, 6398916, 7744726 and 8388803 all of which are incorporated herein in a manner consistent with the present disclosure. When forming multi-ply tissue products, separate plies can be made from the same process or from different processes as desired.

For example, in one embodiment, tissue webs may be creped through-air dried webs formed using processes known in the art. In other embodiments, the base web is formed by an un-creped through-air dried process. Related un-creped through-air dried tissue processes are described for example, in U.S. Pat. Nos. 5,656,132 and 6,017,417, both of which are hereby incorporated by reference herein in a manner consistent with the present disclosure.

Tissue embodiments of the fibrous structures in accordance with the present disclosure may be in the form of through-air-dried fibrous structures, differential density fibrous structures, differential basis weight fibrous structures, wet laid fibrous structures, air-laid fibrous structures, creped or un-creped fibrous structures, pattern-densified or non-pattern-densified fibrous structures, compacted or uncompacted fibrous structures, double re-creped fibrous structures as well known in the art as exemplified in U.S. Pat. Not. 3,301,746, 3,974,025, 4,191,609, 4,637,859 6,398,906 and 8,388,803.

### Air-Laid Processes

“Air-laying” is a well-known process by which a fibrous nonwoven layer can be formed. In the air-laying process, individual or bundles of fibers having typical lengths ranging from about 0.5 to about 52 millimeters (mm) are separated and entrained in an air supply and then deposited onto a forming screen, usually with the assistance of a vacuum supply. The randomly deposited fibers then are bonded to one another using, for example, hot air to activate a binder component or a latex adhesive. Air-laying is taught in, for example, U.S. Pat. Nos. 4,640,810 4,494,278, 5,527,171, 4,375,448, or other similar methods. The webs produced by these methods may subsequently be bonded together to form an adequate tensile strength web by thermal fusing, latex bonding or combinations thereof, which are well known in the art. Webs produced in this text are best exemplified but not limited to the DANWEB process.

Air-laid nonwoven fabrics are particularly well suited for use as wet wipes. The basis weights for air-laid nonwoven fabrics may range from about 30 to about 350 grams per square meter (gsm) with staple fibers having a denier of about 0.5-10 and a length of about 6-15 millimeters. Wet wipe substrates may generally have a fiber dry density of about 0.025 g/cc to about 0.2 g/cc.

A “Layer,” as used herein, means that portion of a ply comprising natural or man-made fibers, fillers and/or other required additives, having some thickness. Layers can be supplied from different sources. For example, different furnishes can be supplied from the same or different headboxes into a single ply structure having multiple distinct layers of interwoven fibers. Each furnish can comprise any combination of fibers, natural or synthetic as discussed supra. Also, without wishing to be limited by theory, it is believed that the layers are not completely discrete and that there is some intermixing of components between the different layers at the boundary between two layers.

Since layers are laid down within a single fibrous structure, they are disposed in a face-to-face relationship. That is the respective length-by-width face of one layer is adjacent to the parallel face of another layer.

As used herein, a “ply” is a fibrous substrate that contains one or more layers. Plies may be processed through a converting process and may be embossed, laminated, or bonded together to create a final fibrous structure. The fibrous structure of the present disclosure contemplates one or more plies disposed in a face-to-face relationship relative to each other. Specifically, a fibrous structure containing two plies can have a first ply having one or more layers and a second ply having one or more layers each engaged in a face-to-face relationship. Each ply can be formed from a plurality of layers each comprising overlapping fibers. However, each ply may comprise different components creating a fibrous structure having a structure with non-uniform layers. The first ply of the at least two plies can comprise a plurality of cellulose nanoparticles and/or other fibers. The second ply of the at least two plies can be essentially free of any nanoparticles or may contain the same or a different quantity of cellulose nanoparticles as the first ply.

“Fiber”, as used herein, means an elongate physical structure having an apparent length greatly exceeding it apparent diameter, i.e. a length to diameter ratio of at least about 10 and less than 200. Fibers having a non-circular cross-section and/or tubular shape are common; the “diameter” in this case may be considered to be the diameter of a circle having cross-sectional area equal to the cross-sectional area of the fiber. More specifically, as used herein, “fiber” refers to fibrous structure-making fibers. The present disclosure contemplates the use of a variety of fibrous structure-making fibers (also referred to herein as “structural fibers”), such as, for example, softwood fibers, non-wood fibers, natural non-cellulosic fibers, man-made cellulosic or non-cellulosic fibers, hardwood fibers, recycled fibers, or any suitable fiber, and mixtures thereof. Fibers can be natural or manmade, further fibers can be virgin or recycled. Man-made fiber can include both those composed of cellulosic materials and non-cellulosic materials. These fibers can be created/produced by any of the processes know by those skilled in the art. In addition, the fibers contemplated in this disclosure include non-wood fibers, hardwood fibers, softwood fibers and man-made fibers, recycled fibers, along with combinations thereof.

Recycled fibers may be added to the furnish in any amount. Recycled fiber contemplated in this disclosure includes both pre-consumer and post-consumer sources. While any suitable recycle fiber may be used, recycled fiber with relatively low levels of ground-wood can be used.

The term “cellulose nanoparticles” as used herein refers to cellulose particles having at least one dimension in the nanoscale. Cellulose nanoparticles include but are not limited to, micro-fibrillated cellulose (MFC), nano-fibrillated cellulose (NFC), algae cellulose particles (AC), bacterial cellulose particles (BC), and high aspect ratio cellulose nanofilaments (CNF). The “cellulose nanoparticles” used in the present disclosure may be derived from either softwood and/or hardwood and as such may contain fibrous elements of the softwood or hardwood.

Micro-fibrillated cellulose (MFC) is hereby defined as fibrous material comprised of cellulosic fibrils, which are very thin, of a diameter of about 5 to 100 nm, in average about 20 nm, and have a fibril length of about 20 nm to 200 μm although usually of 100 nm to 100 μm.

Nano-fibrillated cellulose (NFC) is a specific class of MFC with fiber dimensions at the low end of said fibril size range. In the MFC individual microfibrils are partly or totally detached from each other. Fibers that have been fibrillated and which have microfibrils on the surface and microfibrils that are separated and located in a water phase of a slurry are included in the definition MFC. Cellulose nanoparticles in the present disclosure can be made from any process known by those skilled in the art. Processes used to create cellulose nanoparticles include, but are not limited, to modified refining equipment, homogenizers, sonic fiber treatment, and chemical fiber treatment including enzymatic fiber modification.

The components of micro-fibrillated cellulose are:

| Diameter (μm) | Length | Biological structures | Technological terms |
|---|---|---|---|
| 10 to 50 | 1-3 mm | Tracheid | Cellulose fibre |
| <1 | <75 um | Macrofibrils | Fibrillar fines, fibrils |
| <0.1 | | | Nanofibril, nanofibres |
| <0.035 | | Microfibril | |
| 0.0035 | | Elementary fibril | Elementary fibril |

See Gary Chinga-Carrasco, “Cellulose fibres, nanofibrils and microfibrils: The morphological sequence of MFC components from a plant physiology and fibre technology point of view”, Table 1, Nanoscale Res Lett. 2011; 6(1): 417. Published online 2011 Jun. 13.

“High aspect ratio cellulose nanofilaments” are another subset of MFC with unique dimensions. By high aspect ratio it is meant a fiber length divided by fiber width ranging from at least about 200 to about 5000 or from about 600 to about 1000. These cellulose nanofilaments have an average width in the nanometer range, for example an average width ranging from about 30 nm to about 500 nm, and an average length in the micrometer range or above, for example an average length about 6 μm to about 2.5 mm. Cellulose nanofilaments can have an average thickness ranging from about 20 nm to about 600 nm, or from about 30 nm to about 500 nm. Such cellulose nanoparticles can be obtained, for example, from a mechanical process. An exemplary process is described in U.S. Patent Application Publication Nos. 2013/0017394 and 2015/0057442.

Those skilled in the art will recognize that cellulose nanoparticles are difficult to obtain as a uniform material or “pure form”, and therefore nanoparticle materials many times contain a mixture of material lengths as a result of the mechanical or chemical processes by which they are produced. For example, the exemplary cellulose nanoparticles, have at least about 40%, or at least about 75%, or at least about 90% by weight of the cellulose nanoparticles in the refined mixture with an average particle length above 6 μm and diameters of approximately 30-500 nm.

Another envisioned application of cellulose nanoparticles possible in embodiments contemplated in this disclosure is the inclusion of a small percentage of either pure cellulose nanoparticles and/or a mixture of cellulose nanoparticles and other refining products to a virgin or recycled pulp stream before being shipped to a paper making site. In this way a virgin fiber source can be enhanced via cellulose nanoparticle addition and then the cellulose nanoparticles can be added to a paper making process without introducing a new fiber dosing stream. By dosing cellulose with nanoparticles at a pulp production facility one could produce what could be termed a “super pulp” with characteristics only possible through cellulose nanoparticles inclusion. Therefore many different methods for cellulose nanoparticle addition are considered in the disclosure and these include but are not limited to direct pure cellulose nanoparticle inclusion, including a mixture of cellulose nanoparticles and other refining byproducts with a nanoparticle content of greater than 50% and cellulose nanoparticles being added via inclusion in virgin or recycled fiber before inclusion at the paper mill.

The phrase “Fibrillated cellulose fibers” as use herein, are cellulosic fibers that have undergone mechanical or chemical treatment during which individual or bundles of cellulosic filaments are liberated from the body of the fiber but remain joined to the fiber on one end creating more bonding area and increased fiber to fiber contact. The degree of treatment determines the number of cellulose nanoparticles that have been released from the fiber.

Algae cellulose particles (AC) are the microfibrils extracted from the cell walls of various algae by acid hydrolysis and/or mechanical refining. The resulting microfibrils are microns in length and have a high aspect ratio.

Bacterial cellulose particles (BC) are microfibrils secreted by various bacteria that have been separated from the bacterial bodies and growth medium. The resulting microfibrils are microns in length and have a high aspect ratio.

Those skilled in the art will recognize that the fibrous structure fibers contemplated in the present disclosure can include fibers created from a multitude of sources and base materials. “Fibrillated, man-made, non-cellulose fibers”, are contemplated along with, “Synthetic polymer fibers” and like terminology referring to non-cellulosic fibers made from synthetic polymers such as polyesters, nylons and polyolefins and so forth. Segmented fiber preparation for making splittable fibers is generally known in connection with thermoplastic fibers, where fibers having segments formed of different polymers. See U.S. Pat. Nos. 5,759,926, 5,895,710 and U.S. Patent Application Publication No. 2003/0203695.

The splittable fibers produced and utilized in connection with this disclosure may have a segmented pie shape, an island in the sea configuration, a side-by-side configuration, a hollow configuration and so forth. See U.S. Pat. No. 4,735,849 and U.S. Patent Application Publication No. US 2002/0168912, FIGS. 2-9. Splittable fibers are suitably disintegrated prior to incorporation into the furnish as is discussed below

During the preparation of some fibers for the wet laid paper making operations, softwood fiber and some hardwood fiber pulps are optionally subjected to mechanical or chemical processing whereby the fibers are either compressed, subjected to high shear and/or chemically treated to make the fibers more flexible and create increased fiber to fiber bonding area through fiber fibrillation, fiber swelling and/or increased fiber flexibility. Those skilled in the art will recognize three predominate products of refining a pulp fiber are; 1) a percentage fibers are not impacted at all depending upon refining intensity and consistency, 2) a significant percentage of fibers are fibrillated whereby the fiber cell wall is delaminated and microfibrils are exposed that remain bound to the original fiber, and 3) a percentage of fibers and microfibrils are cut or mechanically broken into very small pieces (<74 micron in length) and this fraction is referred to as the fines fraction. These fines can either be primary (those that exist in the native wood source) or secondary (those created during the act of refining).

The fibrous substrate 100 of the present disclosure can comprise at least one layer comprising nanoparticles 150. A second layer 110 can comprise a plurality of cellulose nanoparticles. This second layer 110 can comprise at least about 0.05 percent, or from about 0.05 percent to about 20 percent, or from about 0.1 percent to about 5 percent by weight of the second layer of nanoparticles.

The first layer 120 of the at least two layers 120 can be free of cellulose nanoparticles. Specifically, the first layer 120 may not contain any directly added cellulose nanoparticles. The first layer 120 can contain no intentionally or willfully added cellulose nanoparticles. “Intentionally” and/or “willfully” as used herein means a voluntary, intentional action having a specific intent to add cellulose nanoparticles to the first layer 120. Such a first layer 120 having no intentionally added cellulose nanoparticles may be observed in that first layer 120 can comprise less than about 0.50 percent, or less than about 0.25 percent, or less than about 0.10 percent, or less than about 0.05 percent by weight of first layer 120 of cellulose nanoparticles.

Those skilled in the art can also envision the first layer 120 also containing nanoparticles, at the same or a very different inclusion than the second layer 110. Specifically, the first layer 120 may contain more or less cellulose nanoparticles, dependent upon the desired attributes of the final product. The first layer 120 can comprise more than about 0.05 percent, or more than about 0.10 percent of cellulose nanoparticles.

By layering the fibrous structured products in a way to vary the levels of cellulose nanoparticle concentrations across the thickness of the overall structure, dramatically expands the formulary options to achieve even higher performing paper products.

“Basis weight,” as used herein, is the weight per unit area of a sample reported in lbs/3000 ft² or g/m² (gsm). Tissue embodiment of the fibrous web substrates of the present disclosure may exhibit a basis weigh of between about 5 g/m² to about 150 g/m², preferably between about 10 g/m² to about 120 g/m², and more preferably between about 20 g/m² to about 100 g/m². Paper embodiments of the fibrous web structures of the present disclosure may exhibit a basis weight of between about 25 g/m² to about 350 g/m², preferably from about 50 g/m² to about 300 g/m², and more preferably from about 75 g/m² to about 250 g/m². Paper board embodiments of the fibrous web structures of the present disclosure may exhibit a basis weight of between about 300 g/m² to about 1000 g/m², preferably from about 400 g/m² to about 800 g/m², and more preferably from about 400 g/m² to about 600 g/m².

Basis weight is measured by preparing one or more samples of a certain area (m²) and weighing the sample(s) of a fibrous structure according to the present disclosure and/or a paper product comprising such fibrous structure on a top loading balance with a minimum resolution of 0.01 g. The balance is protected from air drafts and other disturbances using a draft shield. Weights are recorded when the readings on the balance become constant. The average weight (g) is calculated and the average area of the samples (m²). The basis weight (g/m²) is calculated by dividing the average weight (g) by the average area of the samples (m²).

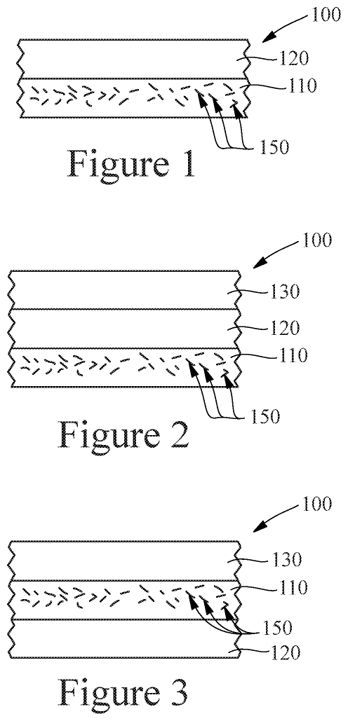

FIG. 1 shows a cross sectional view of an exemplary embodiment of a fibrous structure or ply, 100 of the present disclosure comprising a second layer 110 and a first layer 120. In some embodiments the second layer 110 may comprise a specific mixture of fibers selected from the group consisting of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. A first layer 120 in some embodiments may also contain a specific mixture of fibers selected from the group consisting of softwood fibers, non-wood fibers, natural non-cellulosic fibers, man-made cellulosic or non-cellulosic fibers, hardwood fibers and mixtures thereof, fillers, active ingredients, other fibers, and combinations thereof. The second layer 110 can comprise at least about (i.e., greater than about) 0.05%, or from about 0.05% to about 20%, or from about 0.1% to about 5% by weight of the second layer 110 of nanoparticles.

FIG. 2 shows a cross sectional view of an exemplary embodiment of a fibrous structure or ply 100 of the present disclosure comprising a second layer 110 disposed proximate to the outer surface of the fibrous structure, a first layer 120 and a third layer 130. Each of the three layers (110, 120, and 130) can comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

FIG. 3 shows a cross sectional view of an exemplary embodiment of a fibrous structure or ply 100 of the present disclosure comprising a second layer 110 as one of the inner layers of the fibrous structure, a first layer 120 and a third layer 130 respectively. In some embodiments each layer of the fibrous structure (110, 120, 130) may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

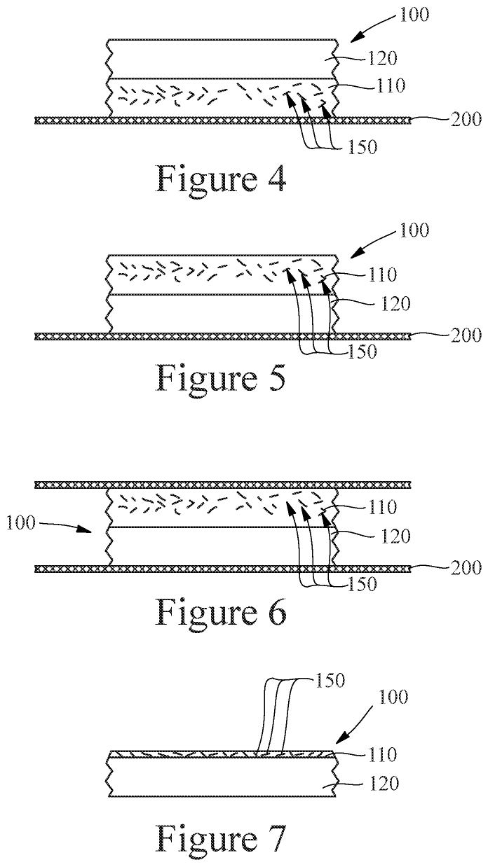

FIG. 4 shows a cross sectional view of an exemplary embodiment of a fibrous structure or ply 100 of the present disclosure comprising a first layer 120 and a second layer 110 where the structure is formed with the second layer 110 formed directly on the forming belt/fabric/wire 200 of the paper making or non-woven machine. The first layer 120 and/or second layer 110 may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

FIG. 5 shows a cross sectional view of an exemplary embodiment of a fibrous structure or ply 100 of the present disclosure comprising a second layer 110 and a first layer 120 where the structure is formed with the second layer 110 formed in a layer away from the forming belt/fabric/wire 200 of a papermaking machine. The first layer 110 and/or second layer 120 may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

FIG. 6 shows a cross sectional view of an exemplary embodiment of a fibrous structure or ply 100 of the present disclosure comprising a first layer 120 and a second layer 110 where the fibrous structure 100 is formed on a dual belt/wire making process where both the first layer 120 and the second layer 120 are formed in contact with one of the two forming belts/fabrics 200 and 210 of the papermaking/non-woven machine. In some embodiments the first layer 120 and/or second layer 110 may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

FIG. 7 shows a cross sectional view of an exemplary embodiment of a fibrous structure or ply 100 of the present disclosure comprising a first layer 110 and a second layer 120 where the second layer 110 is a high concentration of high aspect ratio cellulose nanofilaments. Such a structure may be produced by direct addition of a high concentration of high aspect ratio cellulose nanofilaments such as in a headbox, by spraying, coating, gravure application or other direct application process. Second layer 120 in some embodiments may contain a specific mixture of softwood, recycled material, hardwood, man-made cellulosic or non-cellulosic fibers, fillers and/or active ingredients and/or other fibers. As shown in FIG. 7 the second layer 120 comprises at least about (greater than about) 40.0%, or greater than 50.0%, or from about 55.0% to about 100% high aspect ratio cellulose nanofilaments 150 by weight of the second layer 110.

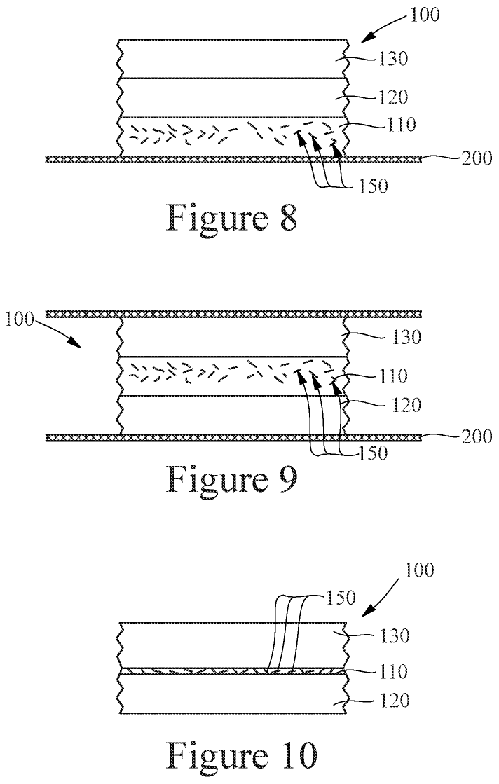

FIG. 8 shows a cross-sectional view of an exemplary embodiment of a fibrous web structure or ply 100 of the present disclosure comprising a first layer 120, a second layer 110, and a third layer 130, where the structure is formed with the second layer 110 formed directly on the forming belt/fabric 200 of a paper making machine. In some embodiments, first layer 120, second layer 110, and/or third layer 130 may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, second layer 110 can comprise greater than about 0.05%, or from about 0.05% to about 20%, or from about 0.1% to about 5% by weight of the fibrous structure of nanoparticles. One skilled in the art could envision second layer 110 being either formed on the wire (150) or on the other side of the fibrous structure (130). In yet another embodiment, the first layer 110 can comprise greater than about 0.05%, or from about 0.05% to about 20%, or from about 0.1% to about 5% by weight of the second layer 110 of nanoparticles

FIG. 9 shows a cross sectional view of an exemplary embodiment of a fibrous structure or ply 100 of the present disclosure comprising a first layer 120, a second layer 110 and a third layer 130, where the fibrous structure 100 is formed on a dual belt/wire making process where both the first layer 120 and the third layer 130 are formed in contact with one of the two forming belts/fabrics 200 and 210 of the papermaking machine. In some embodiments the first layer 120, second layer 110, and third layer 130 may comprise a specific mixture of softwood fibers, non-wood fibers, natural non-cellulosic fibers, man-made cellulosic or non-cellulosic fibers, hardwood fibers, recycled fibers, and mixtures thereof, fillers, active ingredients, other fibers, and combinations thereof. In one embodiment, the second layer 110 can comprise greater than about 0.05%, or from about 0.05% to about 20%, or from about 0.1% to about 5% by weight of the second layer 110 of nanoparticles.

FIG. 10 shows a cross sectional view of an exemplary embodiment of a fibrous structure or ply 100 of the present disclosure comprising a second layer 110, a first layer 120, and a third layer 130, where the second layer 110 has a high concentration of high aspect ratio cellulose nanofilaments. Such a fibrous structure 100 may be produced by the direct addition of a high concentration of cellulose nanoparticles and/or high aspect ratio cellulose nanofilaments, such as in a headbox, by spraying, coating, gravure application, or other direct application process. A first layer 120 and third layer 130 may contain specific mixtures of softwood, recycled material, hardwood, man-made cellulosic or non-cellulosic fibers, fillers and/or active ingredients and/or other fibers. In one embodiment represented in FIG. 10 the second layer 110 comprises at least about (greater than about) 40.0% o, or greater than about 50.0%, or from about 55.0% to about 100% cellulose nanoparticles and/or cellulose nanofilaments and/or high aspect ratio cellulose nanofilaments 150 by weight of the second layer 110.

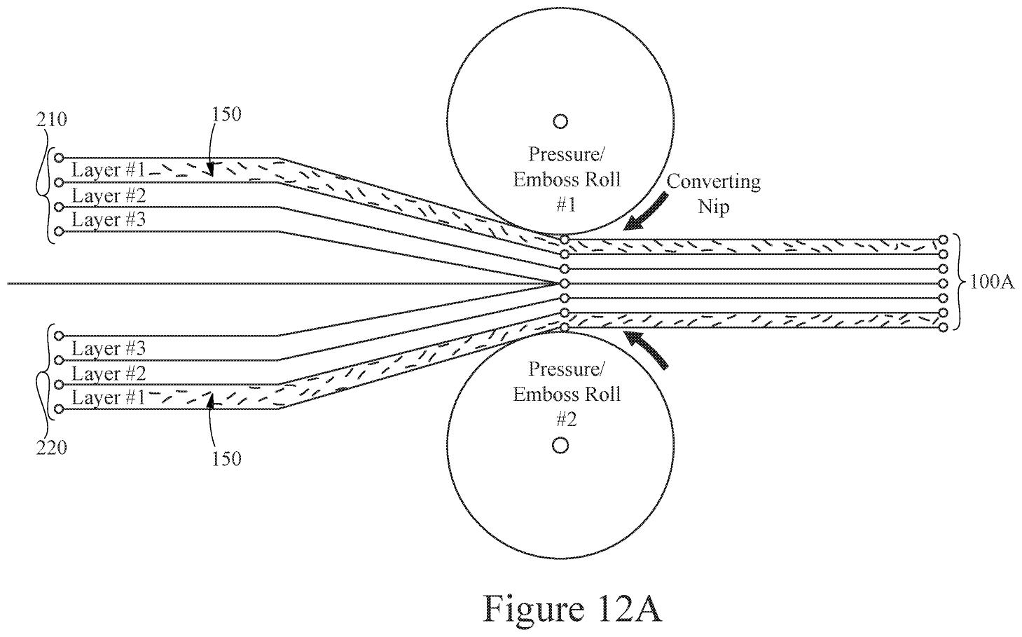

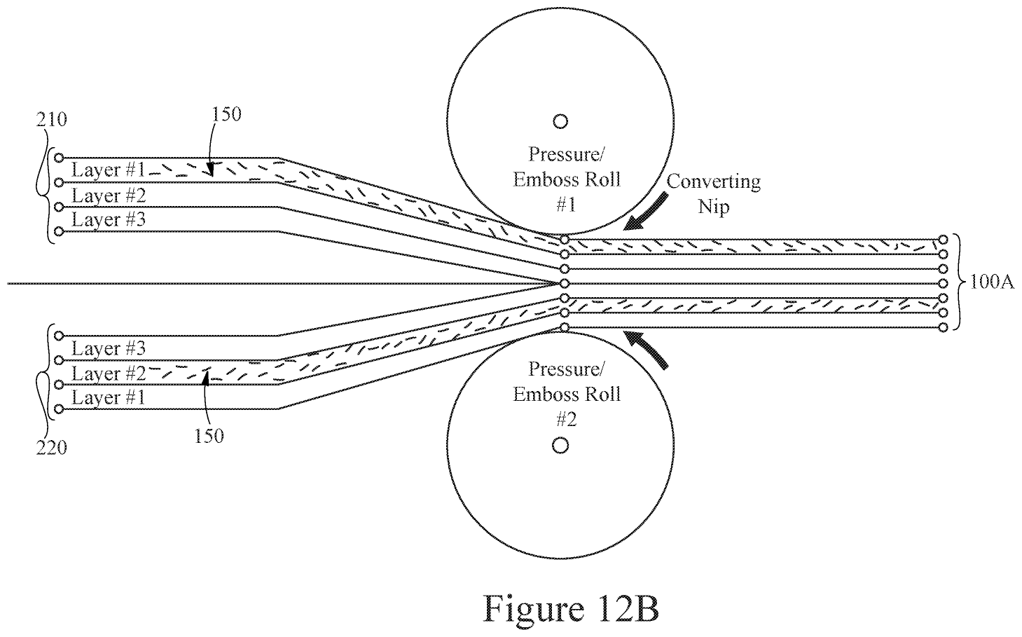

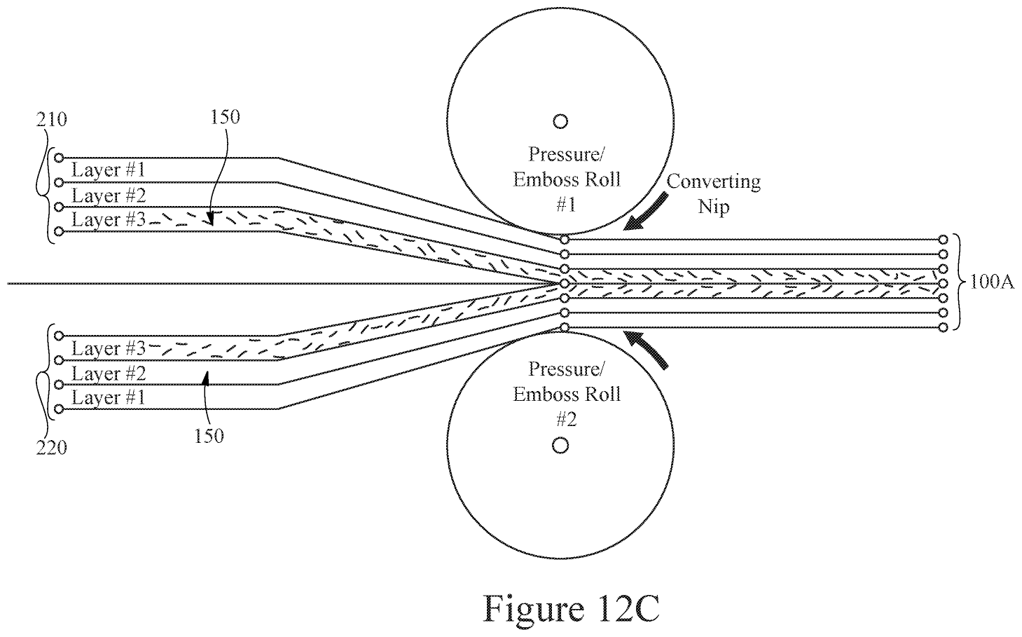

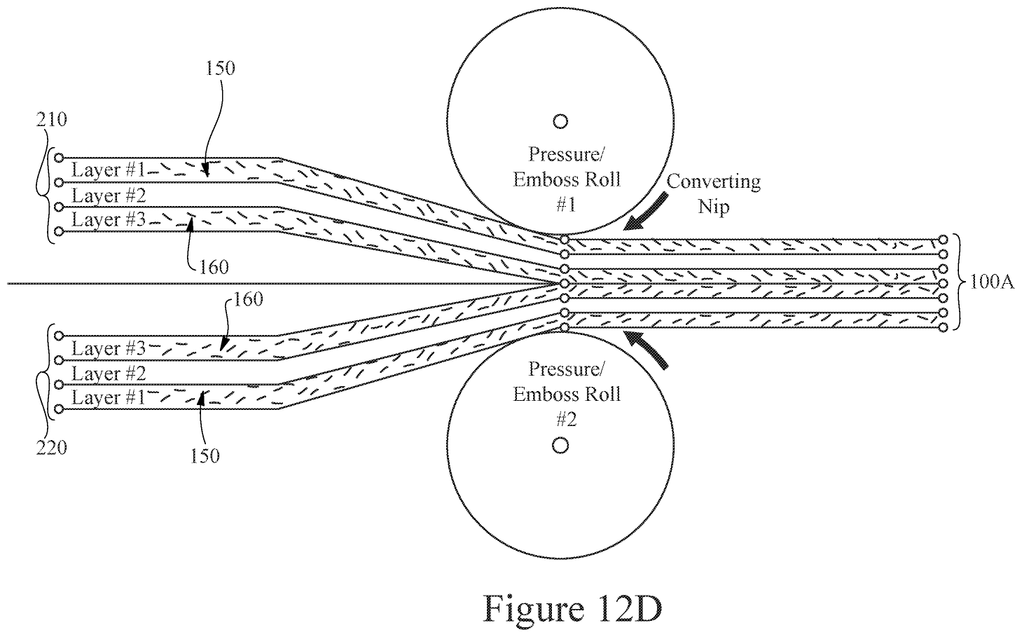

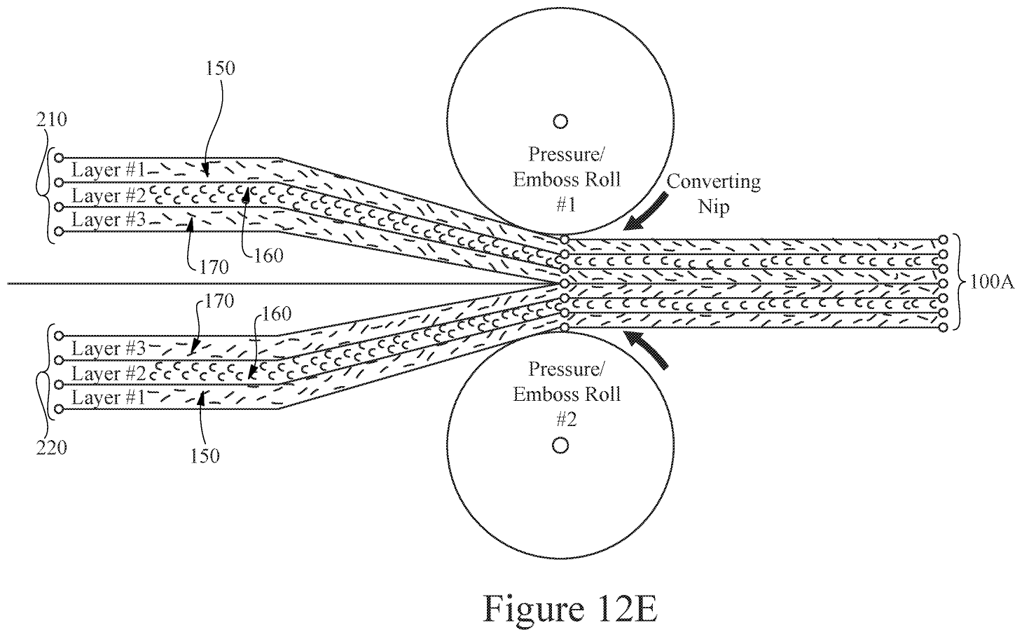

FIG. 12A shows a cross sectional view of an exemplary embodiment of a fibrous structure 100. A of the present disclosure comprising a first ply 210 and a second ply 220, where the first ply 210 has a layered concentration of cellulose nanoparticles that is similar or different than the second ply. Once combined the two plies, each with three layers, creates a different structure and function than a single ply structure. Each ply in some embodiments may also contain layers that may contain a specific mixture of softwood, recycled material, hardwood, man-made cellulosic or non-cellulosic fibers, fillers and/or active ingredients and/or other fibers. In one embodiment represented in FIG. 12A the first ply 210 can comprise three layers. Layer #1 contains at least about (greater than about) 40.0%, or greater than 50.0%, or from about 55.0% to about 100% cellulose nanoparticles 150 by weight of layer #1. Similarly, the second ply 220 comprises three layers and layer #1 can contain at least about (greater than about) 40.0%, or greater than 50.0%, or from about 55.0% to about 100% cellulose nanoparticles 150 by weight of the first layer of the ply 220. Additionally, the first ply 210 can further comprises a second layer (e.g., layer #2). The second layer can comprise no intentionally added cellulose nanoparticles.

Another embodiment envisioned is the combination of layered and non-layered plies to make a final fibrous structure. One skilled in the art can also recognize that a layered ply containing at least one layer comprising a specific mixture of softwood, recycled material, hardwood, man-made cellulosic or non-cellulosic fibers, fillers and/or active ingredients and/or other fibers. In one embodiment the first ply comprises at least two layers. Layer #1 contains at least about (greater than about) 0.05%, or 0.05% to about 20.0% cellulose nanoparticles by weight of layer #1. The second ply is a homogenous fibrous structure that comprises 0.05% to 20% cellulose nano particles by weight of the ply. In another embodiment the second homogenous fibrous ply can contain less than 0.05% cellulose nanoparticles.

In yet another embodiment the first ply can comprise nanoparticles in at least one layer and the nanoparticles can be put in different layers with the same of different inclusion rates. One skilled in the art can envision a large number of structures that can be created by independently varying furnish composition of each ply, each layer in ply one, and the content of cellulose nanoparticles in each layer of the ply and the number of plies combined to create the final structure. One skilled in the art can further envision how applying cellulose nanoparticles into discrete layers of ply one coupled with combining a homogeneous ply either containing or not containing cellulose nanoparticles allows the formulator to further optimize the end product attributes. For many applications the nanoparticle addition can be between 0.05 and 20% by weight of the layer in ply one, or of the homogeneous ply two, but a surface layer comprising greater than 40% nanoparticles by weight of the surface layer is also envisioned.

One skilled in the art can also recognize that there may be an infinite number of structures that can be created by independently varying furnish composition of the layer within each ply, the content of cellulose nanoparticles in each layer of the ply and the number of plies combined to create the final structure. One skilled in the art can further envision how applying cellulose nanoparticles into discrete layers allow the formulator to optimize the end product attributes. Non-limiting samples of example envisioned structures are illustrated in FIGS. 12B, 12C, 12D and 12E. The nanoparticles are envisioned to be in at least one ply in at least one layer and can be put in different layers with the same of different inclusion rates. For many applications the nanoparticle addition can be between 0.05 and 20% of the layer it is being included. In another application the nanoparticle addition can contain less than 0.05% of the layer it is being included.

### Optional Ingredients—Chemical Papermaking Additives

If desired, various chemical additive compositions may optionally be used to further enhance consumer desired benefits such as softness, lower lint, absorbency, sheet flexibility, and temporary and/or permanent wet strengthening additives. Those skilled in the art will recognize that depending upon the papermaking/non-woven process and product end use, different materials can be added to the paper making/non-woven process and non-limiting examples include but are not limited to; mineral additives, optical brighteners, sizing agents, coatings, debonders, silicone softening additives, non-silicone softening additives, strengthening additives, absorbency additives, biocides, retention aids and aesthetic additives.

### Mineral Additives

Many fiber-based products include mineral additives, referred to as fillers. A non-limiting example is Paper product which can primarily comprise a web of cellulosic fibers and defined amounts of mineral and/or organic fillers. Fillers are used, as the name implies, to fill spaces bounded by the cellulosic fibers of the web. Fillers also improve certain paper properties including opacity, brightness and printability. Other additives also can be used to form paper having desirable end-product properties, such as pigments, dyes, starch, sizing agents and strength-enhancing polymers. Traditionally, minerals like Kaolin clay (hydrous aluminum silicate), chalk, ground limestone or marble, (calcium carbonate), talc (hydrous magnesium silicate), gypsum (calcium sulfate), diatomaceous earth (silicon dioxide), and titanium dioxide have been used as fillers. Most other fillers are inorganic materials produced synthetically from minerals (e.g., titanium dioxide, synthetic silica, barium sulfate), or by regeneration after purification (e.g., limestone-to-lime-to-precipitated calcium carbonate). Fillers used to form paper products using methods developed prior to the present disclosure reduce the strength properties, such as breaking length in kilometers of the product (tensile strength divided by the basis weight times 102 by TAPPI Method T494), as the percent of filler used to make such products increases. Depending on the desired characteristics of the desired paper product, the filler can be incorporated in any amount between 0% to about 75%, preferably from about 5% to about 60.0%, more preferably from about 10% to about 50.0%, and even more preferably from about 20% to about 40%, by weight of the dry fiber basis of the paper web structure. The filler can be incorporated into a single layer sheet or in any layer of a multilayer web product.

Strengthening additives—The processes of the present application also comprise the addition of a strengthening additive to the papermaking furnish. Generally, strengthening additives may be applied in various amounts, depending on the desired characteristics of the web. The strengthening additives useful in this disclosure include without limitation cationic water soluble resins. These resins impart wet strength to paper sheets and are well known in paper making art. Such resins include, but are not limited to, polyamide epichlorohydrin (PAE), urea-formaldehyde resins, melamine formaldehyde resins, polyacrylamide resins, dialdehyde starches, and mixtures thereof.

In some embodiments, other strength agents can be utilized to further enhance the strength of a fiber web product. The listing of optional chemical ingredients is intended to barely exemplary in nature and are not meant to limit the scope of the disclosure. Other materials are contemplated as well so long as they do not interfere or counteract the advantages of the present disclosure.

A fibrous structure may comprise at least two plies disposed in a contacting face-to-face relationship. Each of the at least two plies can comprise at least two layers, all disposed in a face-to-face relationship. Each of the at least two layers in each ply can comprise structural fibers selected from the group consisting of softwood fibers, non-wood fibers, man-made cellulosic or non-cellulosic fibers, hardwood fibers, recycled fibers, and mixtures thereof. Each multi-layer ply can comprise a surface layer comprising cellulose nanoparticles. The fibrous structure can join the plies such that the surface layer of each ply becomes a surface layer of the fibrous structure as discussed supra. The surface layers can comprise greater than about 40 percent by weight of the surface layer of cellulose nanoparticles. The cellulose nanoparticles can be applied to a surface layer of the first ply by processes described supra prior to placing the first ply in contacting face-to-face engagement with a surface of a second ply of the at least two plies. Further, the cellulose nanoparticles can be applied to create a surface layer comprising cellulose nanofilaments.

Any dimensions and/or values disclosed herein are not to be understood as being strictly limited to the exact numerical values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising at least two layers, each of said at least two layers comprising a mixture of structural fibers selected from the group consisting of softwood fibers, non-wood fibers, natural non-cellulosic fibers, man-made cellulosic or non-cellulosic fibers, hardwood fibers, recycled fibers, and mixtures thereof, and disposed in a face-to-face relationship, a second layer of said at least two layers comprising from about 0.05 percent to about 20 percent by weight of said second layer of cellulose nanoparticles.

2. The fibrous structure of claim 1 wherein a first layer of said at least two layers comprises from about 0.05 percent to about 20 percent by weight of said second layer of cellulose nanoparticles.

3. The fibrous structure of claim 2 wherein said first layer comprises a different amount by weight of cellulose nanoparticles from an amount by weight of cellulose nanoparticles disposed within said second layer.

4. The fibrous structure of claim 1 wherein a first layer of said at least two layers comprises no intentionally added cellulose nanoparticles.

5. The fibrous structure of claim 1 wherein a first layer of said at least two layers is formed in contact with a forming surface of a paper making machine during production.

6. The fibrous structure of claim 1 wherein said second layer comprises from about 0.1 percent to about 5 percent by weight of said second layer of said cellulose nanoparticles.

7. The fibrous structure of claim 1 wherein said cellulose nanoparticles comprise high aspect ratio nano-filaments.

8. A fibrous structure comprising a surface layer comprising high aspect ratio nano-filaments.

9. The fibrous structure of claim 8 wherein said surface layer comprises at least about 40 percent by weight of said surface layer of said high aspect ratio nanofilaments.

10. The fibrous structure of claim 8 wherein said surface layer comprises greater than about 50 percent by weight of said surface layer of said high aspect ratio nanofilaments.

11. A fibrous structure having a machine direction and a cross-machine direction orthogonal and co-planar thereto and comprising at least two plies disposed in a contacting face-to-face relationship, each of said at least two plies comprising a mixture of structural fibers selected from the group consisting of softwood fibers, non-wood fibers, natural non-cellulosic fibers, man-made cellulosic or non-cellulosic fibers, hardwood fibers, recycled fibers, and mixtures thereof, wherein a first ply of said at least two plies comprises a first layer, said first layer comprising from about 0.05 percent to about 20 percent by weight of said first layer of cellulose nanoparticles.

12. The fibrous structure of claim 11 wherein said first ply further comprises a second layer, said second layer comprising no intentionally added cellulose nanoparticles.

13. The fibrous structure of claim 11 wherein said first ply comprises a second layer, said second layer comprising a different amount by weight of cellulose nanoparticles from an amount by weight of cellulose nanoparticles disposed within said first layer.

14. The fibrous structure of claim 11 wherein said first ply comprises a second layer, said second layer comprising the same amount by weight of cellulose nanoparticles from an amount by weight of cellulose nanoparticles disposed within said first layer.

15. The fibrous structure of claim 11 wherein said fibrous structure further comprises a second ply, said second ply comprising a first layer, said first layer of said second ply comprising from about 0.05 percent to about 20 percent by weight of said second layer of said second ply of cellulose nanoparticles.

16. The fibrous structure of claim 15 wherein said second ply comprises a second layer, said second layer of said second ply comprising a different amount by weight of cellulose nanoparticles from an amount by weight of cellulose nanoparticles disposed within said first layer of said second ply.

17. The fibrous structure of claim 15 wherein said second ply further comprises a second layer, said second layer of said second ply comprising no intentionally added cellulose nanoparticles.

18. The fibrous structure of claim 15 wherein said second ply comprises a second layer, said second layer of said second ply comprising a different amount by weight of cellulose nanoparticles from an amount by weight of cellulose nanoparticles disposed within said first layer of said second ply.

19. The fibrous structure of claim 15 wherein said second ply comprises a second layer, said second layer of said second ply comprising the same amount by weight of cellulose nanoparticles from an amount by weight of cellulose nanoparticles disposed within said first layer of said second ply.
